(19) United States
(12) Patent Application Publication
(10) Pub. No.: US 2009/0320519 A1
(43) Pub. Date: Dec. 31, 2009

(54) Recovery of Hydrofluoroalkanes

(75) Inventors: Sarang Gadre, Bear, DE (US); Shawn Bratt, Hockessin, DE (US); Edgar S. Sanders, JR., Newark, DE (US)

Correspondence Address: AIR LIQUIDE;Intellectual Property, 2700 POST OAK BOULEVARD, SUITE 1800, HOUSTON, TX, 77056, US

(73) Assignee: American Air Liquide, Inc., Fremont, CA (US)

(21) Appl. No.: 12/165,622

(22) Filed: Jun. 30, 2008

(51) Int. Cl. B01D 59/16; F25J 3/00; C01B 21/04

(52) U.S. Cl. 62/606; 62/617; 96/221

(57) ABSTRACT

A mixture of air and one or more halogenated alkanes is directed to a gas separation membrane where it is separated into an oxygen, nitrogen, and moisture-enriched and halogenated alkane-depleted permeate and a halogenated alkane-enriched and oxygen, nitrogen, and moisture-depleted retentate. The retentate is directed to a cryogenic condenser where an amount of halogenated alkane is condensed therein.

### CROSS-REFERENCE TO RELATED APPLICATIONS

None.

### BACKGROUND

Hydrofluoroalkanes (HFAs), alternatively named hydrofluorocarbons, are saturated alkanes wherein one or more of the hydrogens are substituted with a fluorine atom. Chlorofluorocarbons (CFCs) are saturated alkanes wherein at least one or more of the hydrogens are substituted with a fluorine atom and at least one or more of the other hydrogens are substituted with a chlorine atom. Several types of HFAs and CFCs are used in many medical products to propel an active ingredient dispersed or solubilized therein, such as metered dose inhalers, nasal sprays, foam sprays, and other oral sprays. The combined types of HFAs and CFCs may be describe by the compound of formula I:

(CX₃(CX₂)ₙCX₃ (I)

wherein each X is individually H, F, or Cl and at least one X is F and n is an integer in the range of 0-3.

Various types of HFAs include heptafluoropropane (CF₃CFHCF₃), tetrafluoroethane (CF₃—CFH₂), 1,1,1,3,3-pentafluoropropane, 1,1,1,3,3-pentafluorobutane, difluoroethane (CH₃CHF₂) and 1,1,1,2,3,4,4,5,5,5-decafluoropentane. There are numerous CFCs known in the field of pharmaceutical propellants and an exhaustive list need not be recited herein. HFAs and CFCs typically used as propellants in medical products include heptafluoropropane, tetrafluoroethane, trichloromonofluoromethane, dichlorodifluoromethane, and dichlorotetrafluoroethane.

In the final step before packaging, these products are tested at the production facility to make sure proper dose of active ingredients are delivered (Assay test). The resultant sprayed doses containing HFAs are typically driven out by vents using air. Testing large quantities of medical products simultaneously can increase the effluent concentration of HFAs beyond acceptable limits. Since these organic compounds are highly volatile and very potent green house gases, their discharge to the atmosphere needs to be controlled.

### SUMMARY

There is disclosed a method for recovering a halogenated alkane of the formula CX₃(CX₂)ₙCX₃ wherein each X is individually H, F, or Cl and at least one X is F and n is an integer in the range of 0-3. The method comprises the following steps. The gas mixture is directed to a gas separation membrane unit, the gas mixture comprising air and the halogenated alkane. The gas mixture is separated with the gas separation membrane unit into a permeate enriched in oxygen and nitrogen, and depleted in the halogenated alkane and a retentate enriched in the halogenated alkane and depleted in oxygen and nitrogen. The retentate is directed to a cryogenic condenser. An amount of halogenated alkane is condensed from the retentate in the cryogenic condenser. A non-condensed portion of the retentate is condensed from the cryogenic condenser.

There is also disclosed a system for recovering hydrofluoroalkanes from a gas mixture that comprises: a gas separation membrane unit, a cryogenic condenser, a source of liquid nitrogen, and a heat exchanger. The gas separation membrane unit is adapted and configured to separate a gas mixture containing a hydrofluoroalkane and air into a permeate enriched in oxygen and nitrogen and depleted in the hydrofluoroalkane and a retentate enriched in the hydrofluoroalkane and depleted in oxygen and nitrogen. The cryogenic condenser comprises a housing enclosing an inner space, a retentate inlet adapted and configured to receive the permeate from the permeate outlet, a non-condensate outlet adapted and configured to vent a portion of the retentate not condensed by the cryogenic condenser, and a condensate outlet adapted and configured to discharge hydrofluoroalkane condensed from the retentate by the cryogenic condenser. The heat exchanger is disposed within the inner space and including a liquid nitrogen inlet in fluid communication with the source of liquid nitrogen, a gaseous nitrogen outlet, and a metallic heat exchange element having an inner and an outer surface, the inner surface of the heat exchange element defining a flow path in fluid communication between the liquid nitrogen inlet and the gaseous nitrogen outlet, the metallic heat exchange being adapted and configured to condense hydrofluoroalkane from the retentate on the outer surface of the heat exchange element through exchange of heat between the retentate and liquid nitrogen flowing through the flow path.

The method and/or system may include one or more of the following aspects:

the method further comprises the step of compressing the gas mixture before the step of separating is performed.

the cryogenic condenser comprises:
a housing enclosing an inner space, a retentate inlet adapted and configured to receive the permeate from the gas separation membrane unit, a non-condensate outlet adapted and configured to vent a portion of the retentate not condensed by the cryogenic condenser, and a condensate outlet adapted and configured to discharge halogenated alkane condensed from the retentate by the cryogenic condenser;
a source of liquid nitrogen; and
a heat exchanger disposed within the inner space and including a liquid nitrogen inlet in fluid communication with the source of liquid nitrogen, a gaseous nitrogen outlet, and a metallic heat exchange element having an inner and an outer surface, the inner surface of the heat exchange element defining a flow path in fluid communication between the liquid nitrogen inlet and the gaseous nitrogen outlet, the metallic heat exchange being adapted and configured to condense halogenated alkane from the retentate on the outer surface of the heat exchange element through exchange of heat between the retentate and liquid nitrogen flowing through the flow path.

the method further comprises the step of combining a portion of non-condensed retentate from the non-condensate outlet with the gas mixture upstream of the gas separation membrane unit.

the gas separation membrane unit comprises at least one gas separation membrane.

the method further comprises the step of directing at least a portion of non-condensed retentate from the non-condensate outlet to a permeate side of the gas separation membrane to enhance permeance of oxygen and nitrogen through the membrane.

the membrane is configured as a plurality of hollow fibers each comprising a core surrounded by a sheath comprised of a primary gas separation medium.

the primary gas separation medium comprises a polymeric condensation product of 3,3′,4,4′-benzophenone tetracarboxylic dianhydride and 5(6)-amino-1-(4′-aminophenyl)-1,3,3′-trimethylindane.

the primary gas separation medium comprises a 60%:40% blend of a polymer A and polymer B, wherein:
polymer A is a polymeric reaction product of 1,3-diamino mesitylene with 30%/70% mixture of para-isothalic acid and meta-isothalic acid, and
polymer B is a polymeric reaction product of 1,3 diaminobenzene with a 30%/70% mixture of para-isothalic acid/70% meta-isothalic acid.

the primary gas separation medium comprises a copolyimide of 3,3′,4,4′-benzophenone tetracarboxylic dianhydride and 80%/20% mixture of toluenediisocyanate and 4,4′-methylene-bis(phenylisocyanate).

the permeate is enriched in water and the retentate is depleted in water.

the halogenated alkane is a hydrofluoroalkane of the formula CX₃(CX₂)ₙCX₃ wherein each X is individually H or F and at least one X is F and n is an integer in the range of 0-3.

the system further comprises a compressor adapted and configured to compress and direct the gas mixture to said gas separation membrane unit.

the system further comprises a recycle conduit fluidly communicating between said non-condensate outlet and said feed inlet.

the system further comprising a sweep gas conduit fluidly communicating between said non-condensate outlet and a permeate side of said gas separation membrane such that flow of the non-condensate therethrough drives permeation of the oxygen and nitrogen through the membrane.

the method further comprises the step of directing at least a portion of gaseous nitrogen from the gaseous nitrogen outlet to a permeate side of the gas separation membrane.

the system further comprises a sweep gas conduit fluidly communicating between the gaseous nitrogen outlet to a permeate side of the gas separation membrane.

the primary gas separation medium comprises a polymeric material having a selectivity of nitrogen to the halogenated alkane present in the gas mixture of at least 45.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of an embodiment of the invention including a membrane operatively associated with a cryogenic condenser.

FIG. 2 is a schematic of an embodiment of the invention including recycling of a portion of the non-condensate to the gas separation membrane unit.

FIG. 3 is a schematic of an embodiment of the invention including using a portion of the non-condensate as a sweep gas across the permeate side of the gas separation membrane.

FIG. 4 is a schematic of an embodiment of the invention including using a portion of the gaseous nitrogen as a sweep gas across the permeate side of the gas separation membrane.

### DESCRIPTION OF PREFERRED EMBODIMENTS

The concentration of halogenated alkane in an effluent gas mixture of air and sprayed doses of pharmaceutical (containing one or more halogenated alkanes as a propellant) may be significant from an environmental perspective, but is rather low for condensing it out with a cryogenic condenser. Significant energy is required to recover the halogenated alkanes by the cryogenic condensation method. Presence of water in the effluent stream also results in the need for mechanical refrigeration unit and a precondenser for removing water before treating it with the cryogenic condenser.

By first removing substantial amounts of oxygen, nitrogen, and moisture from a gas mixture of one or more halogenated alkanes and air, subsequent cryogenic condensation of the retentate gas can be performed using significantly less liquid cryogen and energy. The water, oxygen and nitrogen preferentially permeate through the membrane over halogenated alkanes. Since water is the fastest molecule with permeability significantly higher than other components in the stream, almost all of water could be removed. At the same time, large portions of oxygen and nitrogen permeate thereby concentrating the concentrations of the halogenated alkanes in the retentate. Removal of water also eliminates the need for mechanical refrigeration and precondenser.

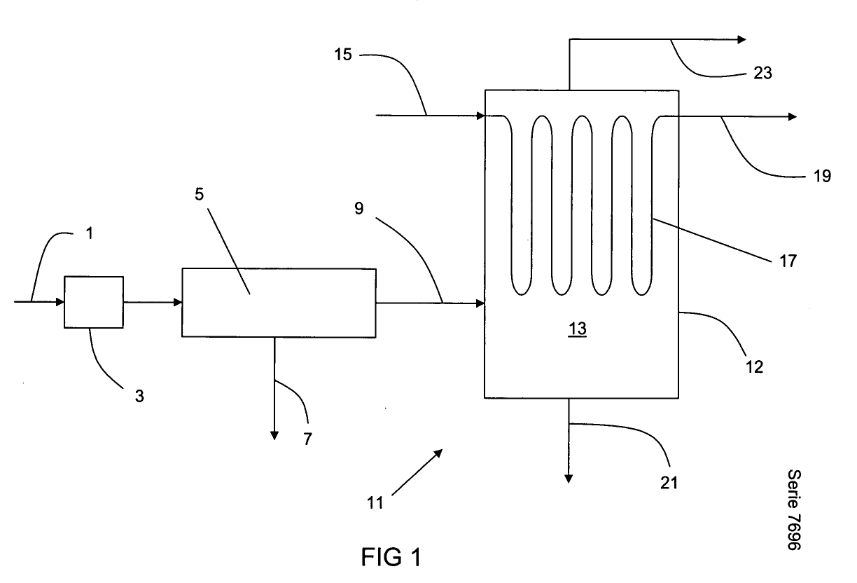

As best shown in FIG. 1, in one embodiment of the invention a stream of a gas mixture 1 of one or more hydrofluoroalkanes (hereafter halogenated alkane) is directed to gas separation membrane unit 5 (with optional compression at optional compressor 3). Since halogenated alkanepermeability in appropriate membrane is much lower compared to other constituents of the effluent stream (e.g., oxygen, nitrogen, and moisture), very good selectivity over halogenated alkaneis possible in several types of polymeric membranes. The gas mixture is separated at unit 5 into an oxygen, nitrogen, and moisture-enriched and halogenated alkane-depleted permeate stream 7 and a halogenated alkane-enriched and oxygen, nitrogen, and moisture-depleted retentate stream 9. Unit 5 includes one or more gas separation membranes. If more than one gas separation membrane is selected, they could be arranged in cascade and/or in parallel fashion.

The membrane includes a primary gas separation medium. The membrane may be configured in a variety of ways: sheet, tube, hollow fiber, etc. In the case of a hollow fiber membrane, either a monolithic or conjugate configuration (a sheath surrounding a core) may be selected. If the monolithic configuration is selected, the primary gas separation medium is uniformly distributed throughout the fiber.

If the conjugate configuration is selected, while the primary gas separation medium present may be present in the core, preferably it is present in the sheath (in such a case the sheath is also called the selective layer) around a core. In this latter configuration, the core has an OD in the range of from about 100 and 2,000 μm, preferably from about 300 μm and 1,500 μm. The core wall thickness is in a range of from about 30 μm to 300 μm, preferably no greater than about 200 μm. The core inner diameter is from about 50 to 90% of its outer diameter. The selective layer is less than about 1 μm thick, preferably less than about 0.5 μm thick. Preferably, the thickness is in a range of from about 150 to 1,000 angstroms. More preferably, the thickness is in a range of from about 300 to 500 angstroms.

When the primary gas separation medium is present in the sheath, the core may be made of several different types of polymeric materials. A non-limiting list of materials suitable for use as the core include polysulfones, ULTEM 1000, or a blend of ULTEM and a polymeric material available under the trade name MATRIMIDE 5218. Ultem 1000 is a polymer represented by Formula II below and is available from a variety of commercial sources, including Polymer Plastics Corp., Reno, Nev. or Modern Plastics, Bridgeport, Conn.).

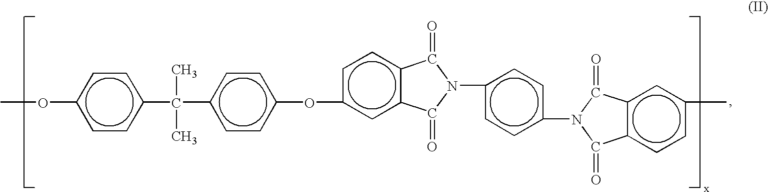

MATRIMID 5218 is the polymeric condensation product of 3,3′,4,4′-benzophenone tetracarboxylic dianhydride and 5(6)-amino-1-(4′-aminophenyl)-1,3,3′-trimethylindane, commercially available from Ciba Specialty Chemicals Corp.

Preferably, the material comprising the primary gas separation medium has a nitrogen to halogenated alkane selectivity of at least 45. A non-limiting list of particular materials for use as the primary gas separation medium includes but is not limited to
Matrimide (preferably a hollow fiber membrane where the core is made of a 95%/5% blend of Ultem and Matrimide;
copolymers of poly(perfluoro-2,2-dimethyl-1,3-dioxole) and tetrafluoroethylene,
a 60%:40% blend of a polymer A and polymer B (preferably a monolithic, hollow fiber membrane)
   wherein polymer A is the polymeric reaction product of 1,3-diamino mesitylene with 30% mixture of para-isothalic acid/70% meta-isothalic acid, and
   wherein polymer B is the polymeric reaction product of 1,3 diaminobenzene with a 30%/70% mixture of para-isothalic acid/70% meta-isothalic acid;
a copolyimide of 3,3′,4,4′-benzophenone tetracarboxylic dianhydride and 80% toluenediisocyanate/20% 4,4′-methylene-bis(phenylisocyanate)
a copolyimide of 3,3′,4,4′-benzophenone tetracarboxylic dianhydride and 80% toluenediisocyanate/20% 4,4′-methylene-bis(phenylisocyanate)
   A particular type of material for use in the primary gas separation medium is a perfluorinated cyclic ether copolymer including repeating units of represented by Formula III. When n is 0.87, such a copolymer is available from Dupont under the trade name Teflon AF2400. When n is 0.65, such a copolymer is available from Dupont under the trade name Teflon AF1600.

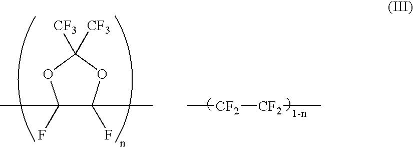

The stream of retentate 9 is directed from the gas separation membrane unit 5 and through a retentate inlet formed in a housing 12 of a cryogenic condenser 11. From there, it proceeds into to an inner space 13 enclosed by the housing 12. A stream of a liquid cryogen 15 (preferably nitrogen) is directed through a heat exchange element 17 contained within inner space 13. The retentate is allowed to flow past the element 17. The relatively low temperature of the liquid cryogen flowing through the element 17 causes the halogenated alkane to condense upon it and collect at a bottom of the condenser 11. The non-condensed portion of the retentate exits the condenser 11 as non-condensate stream 23. The condensed retentate may be allowed to exit the condenser 11 continuously or in batch-wise fashion via condensate stream 21. The condensate may be then be purified and reused or contained or destroyed. Through heat exchange with the retentate, the liquid cryogen vaporizes and exits the condenser 11 via gaseous nitrogen stream 19.

There are many commercially available cryogenic condensers, including the VOXAL cryogenic condenser available from DTA (Grenoble, France) and Air Liquide Advanced Technologies U.S., subsidiaries of Air Liquide. The VOXAL CRYO model can handle a flow of gas to be treated up to 2000 Nm³/hr (1200 scfm) having an inlet VOC (volatile organic compound) concentration greater than 5 g/Nm³ (5000 ppmv). Depending upon the amount of retentate flow into such a unit, the operating temperature within will range from −30° C. (−22° F.) to as low as −170° C. (−274° F.).

While a shell and tube type configuration is shown for condenser 11, many other suitable configurations are possible and are considered within the scope of the invention. One example includes a heat pipe where cold is transferred between the liquid cryogen and the gas mixture by means of an intermediate fluid boiling in tubes maintained at constant temperature. The condenser 11 may also be configured as an exchanger block where heat transfer between the liquid cryogen and gas mixture takes place within two separate flow circuits within a cast aluminum block. Another example is the direct contact exchanger configuration. In this configuration, liquid cryogen is sprayed from a top of a column and onto the gas mixture. The cooled condensate also further cools the gas mixture.

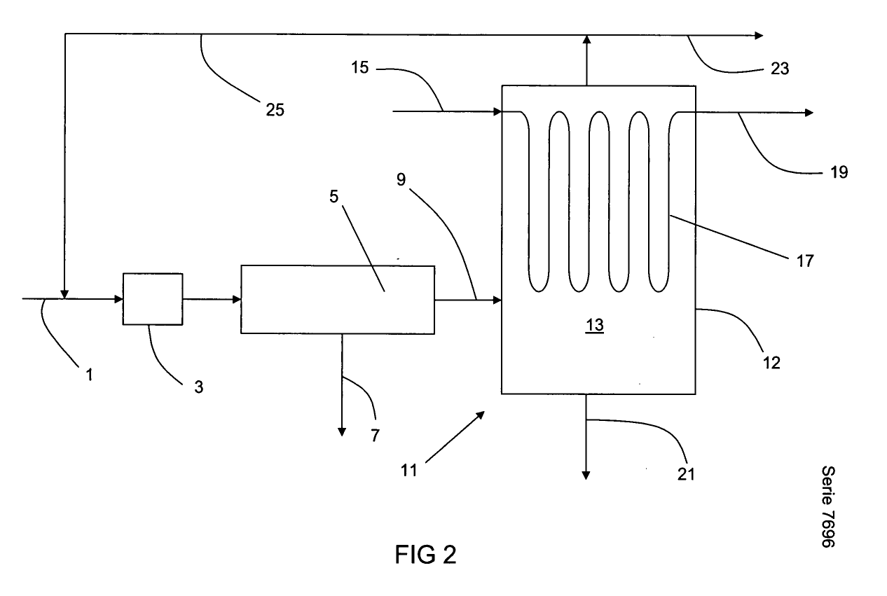

As best illustrated in FIG. 2, a portion of the non-condensate may be directed along recycle conduit 25 back to a feed inlet of the gas separation membrane unit 5. While FIG. 2 depicts a combined flow of the non-condensate and the gas mixture, it is understood that both the non-condensate and the gas mixture may be simultaneously fed to the feed inlet of the unit 5. This is done in order to increase the overall recovery of halogenated alkane. Optionally, the gas mixture and/or non-condensate may be compressed upstream of the unit 5 by optional compressor 3.

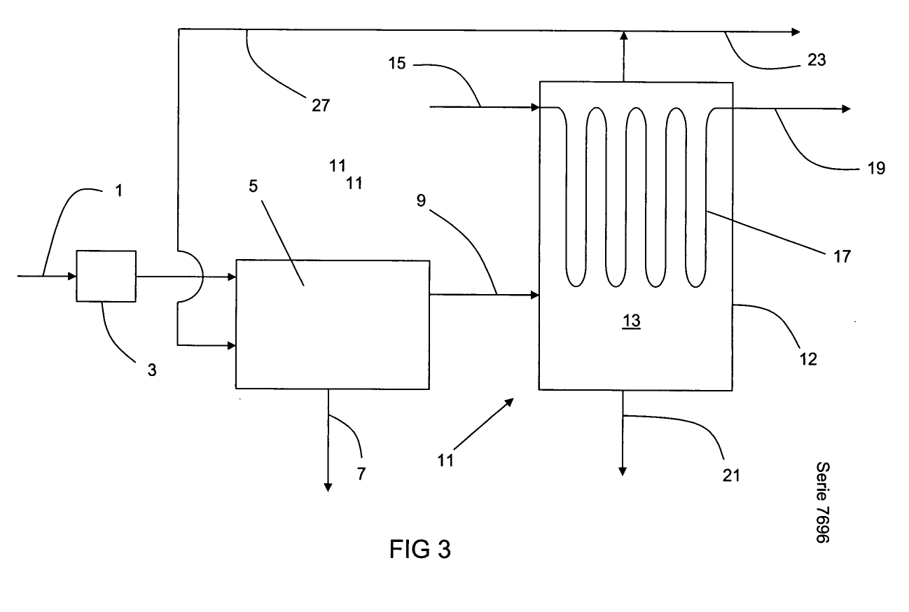

As best shown in FIG. 3, a portion of the non-condensate may be directed through a recycle conduit 27 to a permeate side of the membrane in unit 5. This particular embodiment may be desirable for the purpose of providing a sweep gas across the permeate side to further drive permeation of water across the membrane. One of ordinary skill in the art will appreciate that this particular embodiment is especially advantageous in a membrane cascade. This is because the tendency for the oxygen, nitrogen, and moisture in the non-condensate to inhibit full permeation of oxygen, nitrogen, and moisture across the membrane (in comparison to absence of such a particular sweep gas) is moderated by the enhanced efficiency gained by a two-stage or greater multiple-stage cascade recovery. As in the embodiments of FIGS. 1 and 2, the gas mixture may optionally be compressed by optional compressor 3 upstream of unit 5.

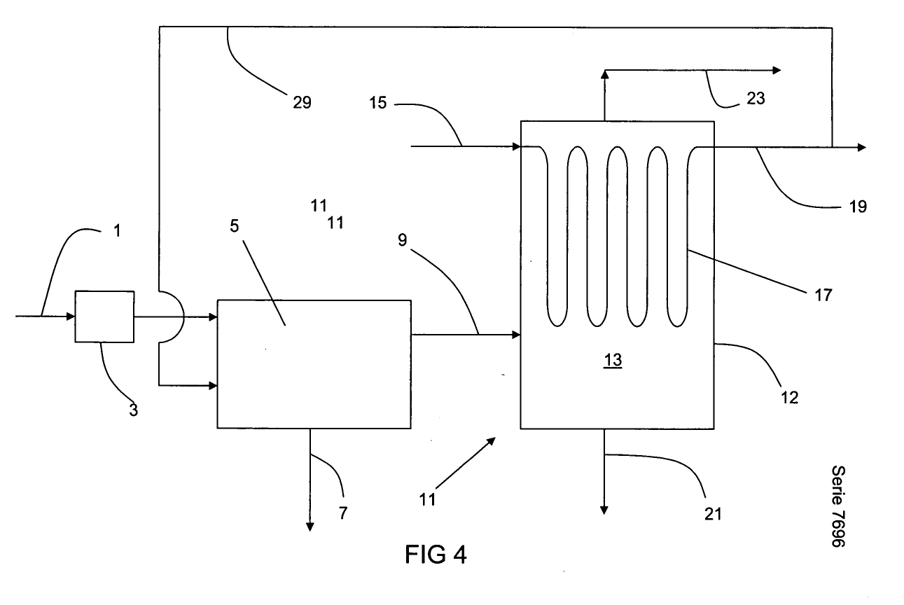

As best shown in FIG. 4, a portion of the stream of gaseous nitrogen 19 may be directed through a sweep gas conduit 29 to a permeate side of the membrane in unit 5. This particular embodiment may be desirable for the purpose of providing a sweep gas across the permeate side to further drive permeation of water and oxygen across the membrane. One of ordinary skill in the art will appreciate that this particular embodiment is especially advantageous in a membrane cascade. This is because the tendency for the nitrogen in the sweep gas to inhibit full permeation of nitrogen across the membrane (in comparison to absence of such a particular sweep gas) is moderated by the enhanced efficiency gained by a two-stage or greater multiple-stage cascade recovery. As in the embodiments of FIGS. 1, 2, and 3, the gas mixture may optionally be compressed by optional compressor 3 upstream of unit 5.

Depending upon the pressure of the effluent stream, it may need to be compressed for carrying out the desired separation.

The membrane's performance may be optimized by adjusting the operating temperature and pressure of the gas separation membrane in an empirical manner. For example, higher temperatures will increase the permeance and reduce the membrane area required for the separation whereas lower temperature will increase the selectivity and reduce the amount of halogenated alkane permeating to the low pressure side.

Likewise, the performance of the cryogenic condenser may be optimized by adjusting its operating temperature and pressure in an empirical manner.

### EXAMPLE

A simulation tool was used to estimate outlet compositions based upon several operating parameters. A gas mixture feed with a temperature of 22 C, a pressure of ambient, and a flow rate of 18.294 kmol/hr was assumed. An HFA concentration of the gas mixture feed was set to 5 g/Nm3. Overall, the molar ratio of the gas mixture feed was set to 0.0135 mols H2O, 0.2070 mols O2, 0.7788 mols N2, and 6.59×10−4 mols HFA. The membrane simulated was a hollow fiber membrane having a core of a 95%/5% blend of Ultem/Matrimide and a sheath of Matrimide.

TABLE I

| | 1 | 2 | 3 | 4 | 5 | 6 |
|---|---|---|---|---|---|---|
| Membrane Operating | 35 | 35 | 80 | 80 | 50 | 50 |
| Temperature (C.) | | | | | | |
| Membrane Operating | 50 | 30 | 50 | 30 | 160 | 160 |
| Pressure (psig) | | | | | | |
| Thermal power (kW) | 3.5 | 3.5 | 10.34 | 10.34 | 6.249 | 6.249 |
| Compression power | 26.41 | 17.96 | 26.41 | 17.96 | 53.91 | 53.91 |
| (kW) | | | | | | |
| Number of bundles | 14 | 23 | 7 | 11 | 3 | 2 |
| Permeate HFA | 0.1725 | 0.1977 | 0.1954 | 0.1986 | 0.1509 | 0.0622 |
| concentration (g/Nm³) | | | | | | |
| Retentate HfA | 114 | 113.3 | 109.8 | 74 | 142.1 | 16.5 |
| concentration (g/Nm³) | | | | | | |
| Retentate/VOXAL inlet | 0.7714 | 0.7774 | 0.8021 | 1.1905 | 0.6251 | 5.5139 |
| flow (kmol/hr) | | | | | | |
| Retentate/Voxal Inlet | 18.24 | 18.64 | 18.97 | 28.15 | 14.78 | 130.40 |
| Flow (std m³/hr) | | | | | | |
| Voxal Outlet | −140.00 | −140.00 | −140.00 | −140.00 | −135.00 | −127.00 |
| Temperature (° C.) | | | | | | |
| Voxal Outlet HFA | 20.26 | 26.15 | 20.26 | 26.15 | 35.00 | 121.00 |
| Concentration | | | | | | |
| (mg/Nm³) | | | | | | |
| Voxal Liquid N₂ | 19.57 | 19.61 | 25.07 | 36.04 | 17.25 | 127.70 |
| Consumption (kg/hr) | | | | | | |
| Voxal Heat Exchange | 1.22 | 1.22 | 1.57 | 2.26 | 1.09 | 8.33 |
| Duty (kW) | | | | | | |

As seen in Table I, use of the membrane at the given parameters decreased the water, O₂, and N₂ concentrations and increased the HFA concentration such that no precondenser is necessary upstream of the cryogenic condenser and 17.25-127.0 kg/hr of liquid N2 was consumed. When a more moderate operating temperature of pressure is used or greater than 2 membrane bundles are used, the liquid N2 consumption drops to only 17.25-36.04 kg/hr. As a result of these simulations, it is seen that the use of the Case 5 conditions is optimal in comparison to Cases 1-4 and 6.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for recovering a halogenated alkane of the formula CX₃(CX₂)ₙCX₃ wherein each X is individually H, F, or Cl and at least one X is F and n is an integer in the range of 0-3, said method comprising the steps of:
directing a gas mixture to a gas separation membrane unit, the gas mixture comprising air and the halogenated alkane;
separating the gas mixture with the gas separation membrane unit into a permeate enriched in oxygen and nitrogen, and depleted in the halogenated alkane and a retentate enriched in the halogenated alkane and depleted in oxygen and nitrogen;
directing the retentate to a cryogenic condenser;
condensing an amount of halogenated alkane from the retentate in the cryogenic condenser; and
withdrawing a non-condensed portion of the retentate from the cryogenic condenser.

2. The method of claim 1, further comprising the step of compressing the gas mixture before said step of separating is performed.

3. The method of claim 1, wherein the cryogenic condenser comprises:
a housing enclosing an inner space, a retentate inlet adapted and configured to receive the permeate from the gas separation membrane unit, a non-condensate outlet adapted and configured to vent a portion of the retentate not condensed by the cryogenic condenser, and a condensate outlet adapted and configured to discharge halogenated alkane condensed from the retentate by the cryogenic condenser;
a source of liquid nitrogen;
a heat exchanger disposed within the inner space and including a liquid nitrogen inlet in fluid communication with the source of liquid nitrogen, a gaseous nitrogen outlet, and a metallic heat exchange element having an inner and an outer surface, the inner surface of the heat exchange element defining a flow path in fluid communication between the liquid nitrogen inlet and the gaseous nitrogen outlet, the metallic heat exchange being adapted and configured to condense halogenated alkane from the retentate on the outer surface of the heat exchange element through exchange of heat between the retentate and liquid nitrogen flowing through the flow path.

4. The method of claim 3, further comprising the step of combining a portion of non-condensed retentate from the non-condensate outlet with the gas mixture upstream of the gas separation membrane unit.

5. The method of claim 3, wherein the gas separation membrane unit comprises at least one gas separation membrane.

6. The method of claim 5, further comprising the step of directing at least a portion of non-condensed retentate from the non-condensate outlet to a permeate side of the gas separation membrane to enhance permeance of oxygen and nitrogen through the membrane.

7. The method of claim 5, wherein the membrane is configured as a plurality of hollow fibers each comprising a core surrounded by a sheath comprised of a primary gas separation medium.

8. The method of claim 7, wherein the primary gas separation medium comprises a polymeric condensation product of 3,3′,4,4′-benzophenone tetracarboxylic dianhydride and 5(6)-amino-1-(4′-aminophenyl)-1,3,3′-trimethylindane.

9. The method of claim 7, wherein the primary gas separation medium comprises a 60%:40% blend of a polymer A and polymer B, wherein:
polymer A is a polymeric reaction product of 1,3-diamino mesitylene with 30%/70% mixture of para-isothalic acid and meta-isothalic acid, and
polymer B is a polymeric reaction product of 1,3 diaminobenzene with a 30%/70% mixture of para-isothalic acid/70% meta-isothalic acid.

10. The method of claim 7, wherein the primary gas separation medium comprises a copolyimide of 3,3′,4,4′-benzophenone tetracarboxylic dianhydride and 80%/20% mixture of toluenediisocyanate and 4,4′-methylene-bis(phenylisocyanate).

11. The method of claim 1, wherein the permeate is enriched in water and the retentate is depleted in water.

12. The method of claim 1, wherein the halogenated alkane is a hydrofluoroalkane of the formula CX₃(CX₂)ₙCX₃ wherein each X is individually H or F and at least one X is F and n is an integer in the range of 0-3.

13. A system for recovering hydrofluoroalkanes from a gas mixture, comprising:
a gas separation membrane unit configured and adapted to separate a gas mixture containing a hydrofluoroalkane and air into a permeate enriched in oxygen and nitrogen and depleted in the hydrofluoroalkane and a retentate enriched in the hydrofluoroalkane and depleted in oxygen and nitrogen, said unit comprising a feed inlet adapted and configured to receive the gas mixture, a permeate outlet adapted and configured to direct the permeate out of said unit, and a retentate outlet adapted and configured to direct the retentate out of said unit;
a cryogenic condenser comprising a housing enclosing an inner space, a retentate inlet adapted and configured to receive the permeate from said permeate outlet, a non-condensate outlet adapted and configured to vent a portion of the retentate not condensed by said cryogenic condenser, and a condensate outlet adapted and configured to discharge hydrofluoroalkane condensed from the retentate by said cryogenic condenser;
a source of liquid nitrogen;
a heat exchanger disposed within said inner space and including a liquid nitrogen inlet in fluid communication with said source of liquid nitrogen, a gaseous nitrogen outlet, and a metallic heat exchange element having an inner and an outer surface, said inner surface of the heat exchange element defining a flow path in fluid communication between said liquid nitrogen inlet and said gaseous nitrogen outlet, said metallic heat exchange being adapted and configured to condense hydrofluoroalkane from the retentate on said outer surface of the heat exchange element through exchange of heat between the retentate and liquid nitrogen flowing through said flow path.

14. The system of claim 13, further comprising a compressor adapted and configured to compress and direct the gas mixture to said gas separation membrane unit.

15. The system of claim 13, further comprising recycle conduit fluidly communicating between said non-condensate outlet and said feed inlet.

16. The system of claim 13, wherein said gas separation membrane unit comprises a gas separation membrane.

17. The system of claim 16, further comprising a sweep gas conduit fluidly communicating between said non-condensate outlet and a permeate side of said gas separation membrane such that flow of the non-condensate therethrough drives permeation of the oxygen and nitrogen through the membrane.

18. The system of claim 16, wherein the membrane is configured as a plurality of hollow fibers each comprising a core surrounded by a sheath comprised of a primary gas separation medium.

19. The system of claim 15, wherein the primary gas separation medium comprises a polymeric condensation product of 3,3′,4,4′-benzophenone tetracarboxylic dianhydride and 5(6)-amino-1-(4′-aminophenyl)-1,3,3′-trimethylindane.

20. The system of claim 15, wherein the primary gas separation medium comprises a 60%:40% blend of a polymer A and polymer B, wherein:
polymer A is a polymeric reaction product of 1,3-diamino mesitylene with 30%/70% mixture of para-isothalic acid and meta-isothalic acid, and
polymer B is a polymeric reaction product of 1,3 diaminobenzene with a 30%/70% mixture of para-isothalic acid/70% meta-isothalic acid.

21. The system of claim 15, wherein the primary gas separation medium comprises a copolyimide of 3,3′,4,4′-benzophenone tetracarboxylic dianhydride and 80%/20% mixture of toluenediisocyanate and 4,4′-methylene-bis(phenylisocyanate).

22. The method of claim 1, wherein the primary gas separation medium comprises a polymeric material having a selectivity of nitrogen to the halogenated alkane present in the gas mixture of at least 45.

23. The method of claim 5, further comprising the step of directing at least a portion of gaseous nitrogen from the gaseous nitrogen outlet to a permeate side of the gas separation membrane.

24. The system of claim 16, further comprises a sweep gas conduit fluidly communicating between the gaseous nitrogen outlet to a permeate side of the gas separation membrane.
